(19) United States
(12) Patent Application Publication
(10) Pub. No.: US 2015/0316369 A1
(43) Pub. Date: Nov. 5, 2015

(54) FILM THICKNESS MEASUREMENT DEVICE

(71) Applicant: Sharp Kabushiki Kaisha, Osaka-shi, Osaka (JP)

(72) Inventors: Norikazu HOHSHI, Osaka-shi (JP); Hidekazu SAKAGAMI, Yao-shi (JP); Narumi HARADA, Yao-shi (JP); Chiaki YAMAWAKI, Yao-shi (JP)

(73) Assignee: Sharp Kabushiki Kaisha, Osaka-shi, Osaka (JP)

(21) Appl. No.: 14/420,712

(22) PCT Filed: Aug. 23, 2013
(86) PCT No.: PCT/JP2013/072578

§ 371 Date: Feb. 10, 2015

(30) Foreign Application Priority Data
Sep. 7, 2012 (JP) 2012-197634

(51) Int. Cl. G01B 15/02; G01N 23/223

(52) U.S. Cl. CPC G01B 15/02; G01N 23/223

(57) ABSTRACT

Substrate aluminum detection means (33a) irradiates a substrate (11) before film formation with primary X-rays from a measurement head (23) and detects fluorescent X-rays generated from the substrate (11) by the measurement head (23) to detect an aluminum component contained in the substrate (11). When an aluminum film is formed on the substrate (11), aluminum film correction means (33b) corrects intensity of fluorescent X-rays detected from the aluminum film by the measurement head (23) based on a detection result of the substrate aluminum detection means (33a) to obtain thickness of the aluminum film.

### TECHNICAL FIELD

The present invention relates to a film thickness measurement device that measures thickness of a film on a substrate.

### BACKGROUND ART

In general, there has been a film thickness measurement device described in Japanese Unexamined Patent Application Publication No. 3-94444 (PTL 1). This film thickness measurement device irradiates a film on a substrate with primary X-rays to detect fluorescent X-rays generated from the film and obtains film thickness from intensity of these fluorescent X-rays.

Meanwhile, as illustrated in FIG. 8, in a case where an aluminum film 102 which is composed of aluminum is layered on a substrate 101 and the substrate 101 is, for example, a glass substrate of Al₂O₃ and contains an aluminum component, when irradiating the aluminum film 102 with primary X-rays 150, fluorescent X-rays 151 generated from aluminum in the substrate 101 are detected in addition to fluorescent X-rays 152 generated from aluminum in the aluminum film 102.

In this manner, there is a problem that it is difficult to obtain thickness of the aluminum film 102 correctly due to influences of the aluminum component contained in the substrate 101. Particularly, the aluminum component contained in the substrate 101 fluctuates for each substrate 101 in some cases, so that it has been difficult to perform correction uniformly.

### CITATION LIST

### Patent Literature

PTL 1: Japanese Unexamined Patent Application Publication No. 3-94444

### SUMMARY OF INVENTION

### Technical Problem

Accordingly, an object of the present invention is to provide a film thickness measurement device capable of excluding influences of aluminum contained in a substrate of a product substrate and obtaining thickness of an aluminum film correctly.

### Solution to Problem

In order to solve the aforementioned problem, the present invention provides a film thickness measurement device, includes: a base; a substrate stage which is provided on the base and on which a product substrate having a film is placed; a gantry that extends in a first direction with respect to the substrate stage and is installed in the base so as to be movable in a second direction with respect to the substrate stage; a slider that is installed in the gantry so as to be movable in the first direction; a measurement head that is fixed to the slider and irradiates a film of the product substrate placed on the substrate stage with primary X-rays to detect fluorescent X-rays generated from the film; and analysis means that obtains thickness of the film from intensity of the fluorescent X-rays detected by the measurement head. The analysis means includes substrate aluminum detection means that irradiates a substrate before film formation of the product substrate with the primary X-rays from the measurement head and detects fluorescent X-rays generated from the substrate by the measurement head to detect an aluminum component contained in the substrate, and aluminum film correction means that, when an aluminum film composed of aluminum is included in the film of the product substrate, corrects intensity of the fluorescent X-rays detected from the aluminum film by the measurement head based on a detection result of the substrate aluminum detection means to obtain thickness of the aluminum film.

Here, the product substrate has the substrate and the film having one or more layers, which is formed on the substrate.

According to the film thickness measurement device of the present invention, the substrate aluminum detection means irradiates the substrate before film formation of the product substrate with the primary X-rays from the measurement head, and detects the fluorescent X-rays generated from the substrate by the measurement head to detect the aluminum component contained in the substrate. When the aluminum film composed of aluminum is included in the film of the product substrate, the aluminum film correction means corrects the intensity of the fluorescent X-rays detected from the aluminum film by the measurement head based on the detection result of the substrate aluminum detection means to obtain the thickness of the aluminum film.

Accordingly, when the thickness of the aluminum film is obtained from the intensity of the fluorescent X-rays of the aluminum film detected by the measurement head, it is possible to exclude influences of aluminum contained in the substrate of the product substrate and to obtain the thickness of the aluminum film correctly.

Moreover, in the film thickness measurement device of one embodiment, the substrate aluminum detection means detects the aluminum component of the substrate before film formation for each of all the product substrates.

According to the film thickness measurement device of this embodiment, the substrate aluminum detection means detects the aluminum component of the substrate before film formation for each of all the product substrates. This makes it possible to obtain the thickness of the aluminum film for all the product substrates more accurately.

Moreover, in the film thickness measurement device of one embodiment, the substrate aluminum detection means detects the aluminum component of the substrate before film formation for each lot of all the product substrates.

According to the film thickness measurement device of this embodiment, the substrate aluminum detection means detects the aluminum component of the substrate before film formation for each lot of all the product substrates. Accordingly, the thickness of the aluminum film is obtained based on the aluminum component of the substrate before film formation for each lot of all the product substrates, thus making it possible to obtain the thickness of the aluminum film promptly and accurately.

Moreover, in the film thickness measurement device of one embodiment, the substrate aluminum detection means detects the aluminum component of the substrate before film formation for at least one product substrate of all the product substrates.

According to the film thickness measurement device of this embodiment, the substrate aluminum detection means detects the aluminum component of the substrate before film formation for at least one product substrate of all the product substrates. Accordingly, the thickness of the aluminum film is obtained based on the aluminum component of the substrate before film formation of at least one product substrate, thus making it possible to obtain the thickness of the aluminum film promptly.

Moreover, in the film thickness measurement device of one embodiment, when the substrate aluminum detection means detects the aluminum component of the substrate, a measurement position of the substrate to be measured by the measurement head is overlapped with a spatial region provided in the substrate stage.

According to the film thickness measurement device of this embodiment, the measurement position of the substrate to be measured by the measurement head is overlapped with the spatial region provided in the substrate stage. Accordingly, even if a lot of primary X-rays penetrate the substrate when the substrate is irradiated with the primary X-rays from the measurement head to detect the fluorescent X-rays from the substrate, these primary X-rays penetrated are to pass through the spatial region of the substrate stage.

Therefore, it is possible to avoid the substrate stage being irradiated with these primary X-rays which have penetrated the substrate and to prevent the measurement head from detecting fluorescent X-rays generated from a material constituting the substrate stage. Thus, it is possible to detect the aluminum component of the substrate accurately.

Moreover, in the film thickness measurement device of one embodiment, the spatial region provided in the substrate stage is an air hole for taking in air or blowing air.

According to the film thickness measurement device of this embodiment, the spatial region provided in the substrate stage is the air hole. Accordingly, when the substrate is measured by the measurement head, it is possible that the substrate closely adheres to the substrate stage by air taken from the air hole. Thus, it is possible to measure the measurement position of the substrate in a state in which height of the measurement position of the substrate is stabilized.

### Advantageous Effects of Invention

According to the film thickness measurement device of the present invention, since the substrate aluminum detection means and the aluminum film correction means are included, it is possible to exclude influences of aluminum contained in the substrate of the product substrate and to obtain the thickness of the aluminum film correctly.

### BRIEF DESCRIPTION OF DRAWINGS

FIG. 1 is a plan view illustrating a film thickness measurement device of one embodiment of the present invention.

FIG. 2 is a side view of the film thickness measurement device as viewed in an arrow U direction in FIG. 1.

FIG. 3 is an explanatory view for explaining operation of a displacement sensor.

FIG. 4 is an explanatory view for explaining operation of a measurement head.

FIG. 5 is an explanatory view for explaining a state in which fluorescent X-rays are generated by irradiation of primary X-rays.

FIG. 6A is a table illustrating a relation between X-ray intensity and film thickness in a titanium film and a molybdenum film.

FIG. 6B is a graph in which data in FIG. 6A is plotted.

FIG. 7 is an explanatory view for explaining a state in which a substrate before film formation of a product substrate is measured by the measurement head.

FIG. 8 is an explanatory view for explaining measurement of film thickness according to the related art.

### DESCRIPTION OF EMBODIMENTS

The present invention will be described in detail below with an embodiment illustrated in the figures.

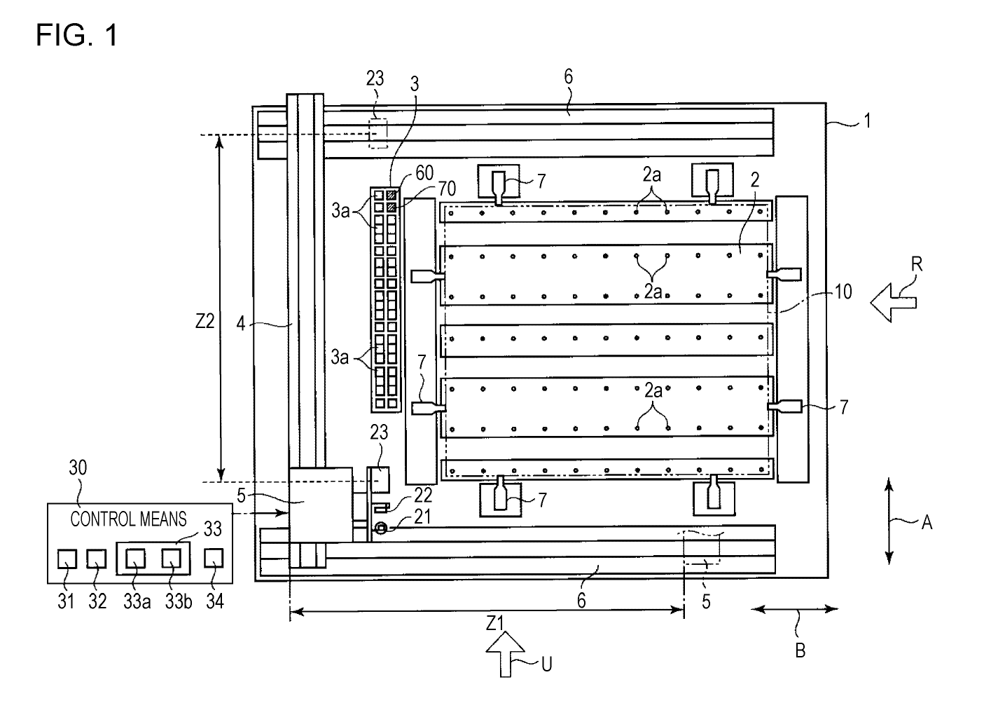

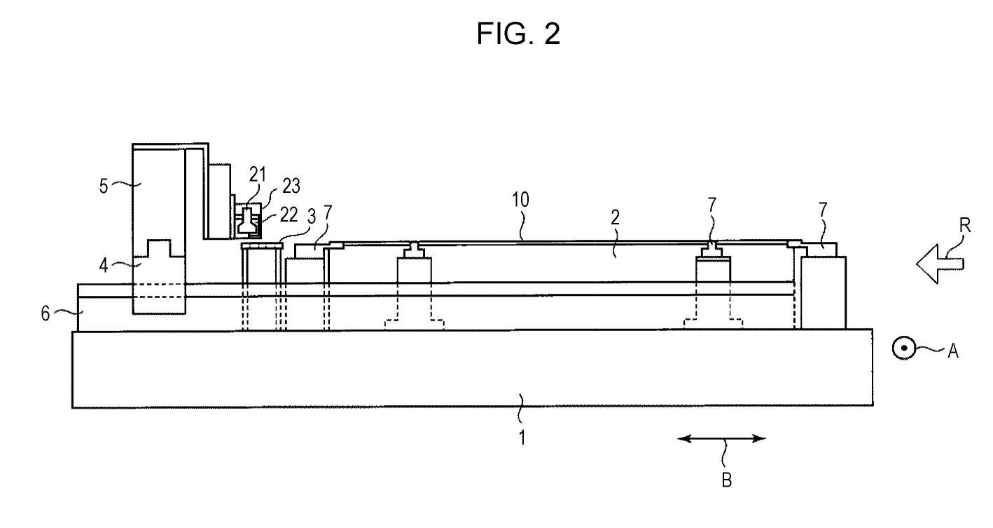

FIG. 1 is a plan view illustrating a film thickness measurement device of one embodiment of the present invention. FIG. 2 is a side view as viewed in an arrow U direction in FIG. 1. As illustrated in FIG. 1 and FIG. 2, this film thickness measurement device has a base 1, a substrate stage 2, a calibration stage 3, a gantry 4, a slider 5, a plurality of measurement equipment 21, 22 and 23, and control means 30.

The substrate stage 2 is provided on the base 1 and composed of a plurality of divided stages. A product substrate 10 in which a film is formed is placed on the substrate stage 2.

A plurality of air holes 2a are provided on the substrate stage 2, and the product substrate 10 is able to be closely adhered to the substrate stage 2 by taking in air from these air holes 2a, while the product substrate 10 is able to be floated from the substrate stage 2 by blowing air from the air holes 2a.

The product substrate 10 is, for example, a liquid crystal TFT used for a liquid crystal display. This product substrate 10 has a substrate and a film having one or more layers, which is formed on this substrate. The film is formed on the substrate, for example, with a sputtering method, a vapor deposition method or a plating method. The substrate is, for example, a glass substrate, and the film is, for example, a metal film of aluminum, titanium, tungsten, molybdenum or the like.

The calibration stage 3 is provided on the base 1 and provided separately from the substrate stage 2. This calibration stage 3 is provided with a plurality of concave units 3a, various types of calibration samples 60 and 70 are embedded in these concave units 3a, and calibration of the measurement equipment 21, 22 and 23 is performed by using these calibration samples 60 and 70.

The gantry 4 extends in a first direction with respect to the substrate stage 2 and the calibration stage 3. The gantry 4 is installed in the base 1 so as to be movable in a second direction with respect to the substrate stage 2 and the calibration stage 3. The first direction refers to an arrow A direction and the second direction refers to an arrow B direction. The first direction and the second direction are orthogonal with each other.

That is, two rail units 6 and 6 which extend in the second direction (arrow B direction) are provided on the base 1. These two rail units 6 and 6 are arranged so as to place the substrate stage 2 and the calibration stage 3 therebetween. The gantry 4 is laid across these two rail units 6 and 6 and is movable in the second direction along these rail units 6 and 6.

The slider 5 is installed in the gantry 4 so as to be movable in the first direction (arrow A direction). To this slider 5, a camera 21, a displacement sensor 22 and a measurement head 23 as the measurement equipment are fixed.

Further, the measurement equipment 21, 22 and 23 are able to cover an entire range of the substrate stage 2 and the calibration stage 3 in the second direction (arrow B direction) by a movable range Z1 of the gantry 4. In addition, the measurement equipment 21, 22 and 23 are able to cover an entire range of the substrate stage 2 and the calibration stage 3 in the first direction (arrow A direction) by a movable range Z2 of the slider 5.

The control means 30 has substrate position correction means 31, head position adjustment means 32, analysis means 33, and measurement equipment calibration means 34.

The camera 21 detects an alignment mark of the product substrate 10 placed on the substrate stage 2. This alignment mark is a mark which is able to be judged by the camera 21, and is provided, for example, at four corners of the product substrate 10.

The substrate position correction means 31 corrects position information of plane directions (first and second directions) of the product substrate 10 placed on the substrate stage 2 based on a detection result of the camera 21. Specifically, the base 1 is provided with a plurality of clamps 7 so as to press each surrounding side of the product substrate 10. After the product substrate 10 is fixed at a predetermined position by the clamps 7, the alignment mark is detected by the camera 21, and based on this detection result, the position information of the product substrate 10 is corrected by the substrate position correction means 31.

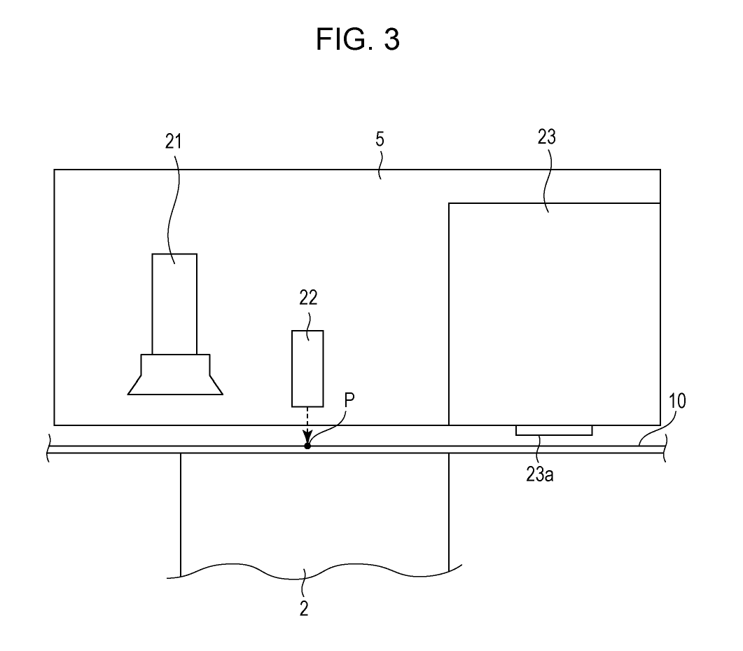

As illustrated in FIG. 3, the displacement sensor 22 measures distance in a height direction to the product substrate 10 placed on the substrate stage 2. The displacement sensor 22 measures distance to a predetermined measurement point P of the product substrate 10 by using rays such as, for example, infrared rays.

The head position adjustment means 32 adjusts a position in a height direction of the measurement head 23 based on a measurement value of the displacement sensor 22 so that distance between the product substrate 10 placed on the substrate stage and the measurement head 23 has a predetermined setting value. Specifically, distance in the height direction between the measurement point P of the product substrate 10 and a light reception and emission unit 23a of the measurement head 23 is adjusted so as to be 2 mm±30 μm.

Moreover, after adjusting the position in the height direction of the measurement head 23, the head position adjustment means 32 moves the measurement head 23 to a position where the measurement head 23 is able to measure the measurement point P of the product substrate 10.

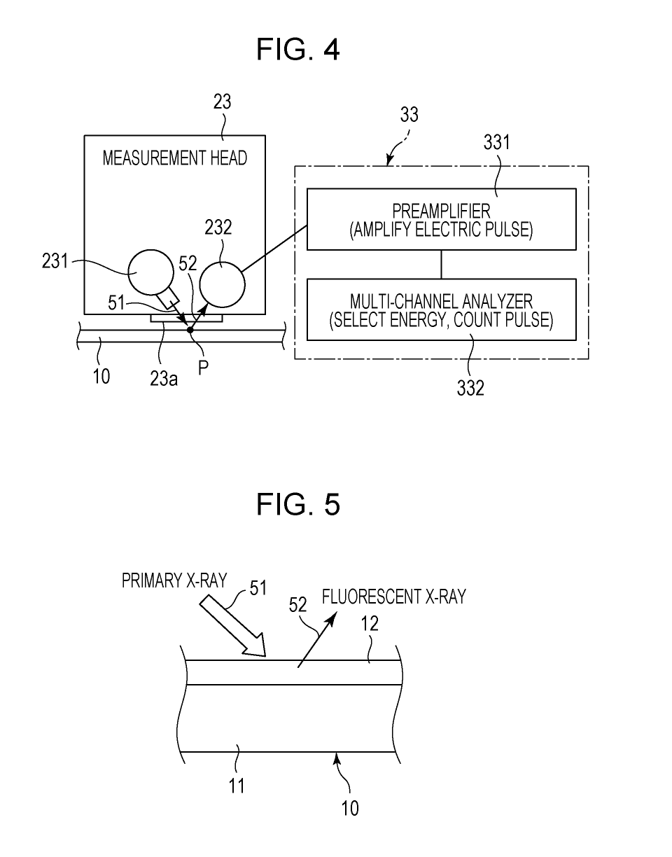

As illustrated in FIG. 4, the measurement head 23 has an X-ray irradiation unit 231 and a fluorescent X-ray detection unit 232.

The X-ray irradiation unit 231 irradiates the measurement point P of the product substrate 10 with primary X-rays 51 from the light reception and emission unit 23a. The primary X-rays 51 are, for example, rhodium, molybdenum, tungsten or the like. Then, as illustrated in FIG. 5, a film 12 on a substrate 11 of the product substrate 10 generates fluorescent X-rays 52 by irradiation of the primary X-rays 51.

The fluorescent X-ray detection unit 232 detects the fluorescent X-rays 52, which are generated from the film 12, from the light reception and emission unit 23a. The fluorescent X-ray detection unit 232 is, for example, a silicon drift detector.

The analysis means 33 obtains thickness of the film 12 from intensity of the fluorescent X-rays 52 detected by the measurement head 23. Specifically, the analysis means 33 has a preamplifier 331 and a multi-channel analyzer (hereinafter, referred to as MCA) 332.

The preamplifier 331 amplifies an electric signal output from the fluorescent X-ray detection unit 232. The MCA 332 analyzes the electric signal amplified with the preamplifier 331. At the MCA 332, by selecting energy output from the fluorescent X-ray detection unit 232 to count pulse, X-ray intensity of an element which constitutes the film 12 is obtained. Then, based on this X-ray intensity, the thickness of the film 12 is obtained from known data. Note that, since the MCA 332 is used, it is possible to detect a foreign substance and an impure substance which are included in the film 12.

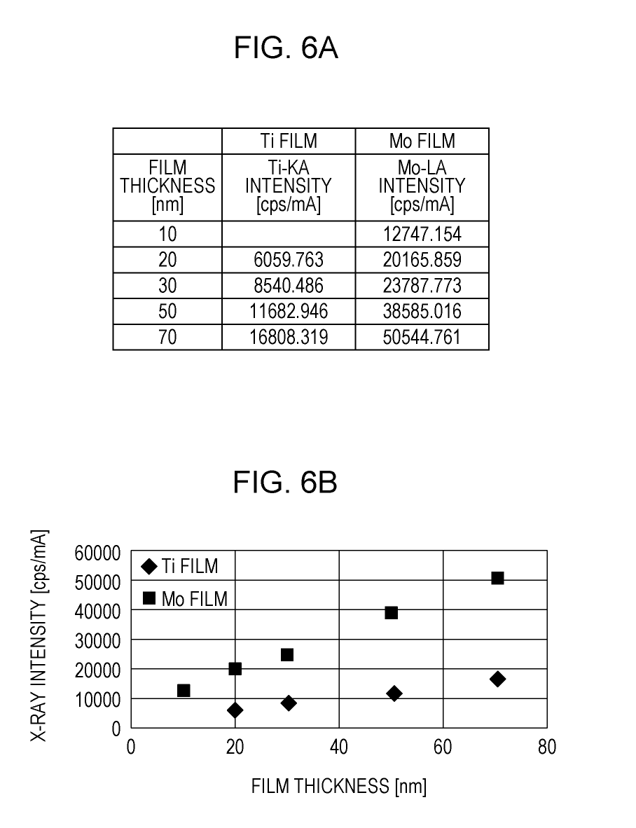

For example, when the film 12 is a titanium film or a molybdenum film, a relation between the X-ray intensity and the film thickness becomes a relation as illustrated in FIG. 6A and FIG. 6B.

Note that, though description has been given above for measurement of the thickness of the film having a single layer (FIG. 5), it is also possible to measure the thickness of a film having a plurality of layers. In this case, fluorescent X-rays generated from each film are detected by the measurement head 23, and, by the analysis means 33, X-ray intensity of each element constituting each film is obtained, and the thickness of each film is obtained based on this X-ray intensity. Furthermore, it is also possible to obtain a composition ratio of each element from this X-ray intensity of each element.

As illustrated in FIG. 1, the analysis means 33 further has substrate aluminum detection means 33a and aluminum film correction means 33b.

The substrate aluminum detection means 33a irradiates the substrate 11 before film formation of the product substrate 10 with the primary X-rays from the measurement head 23, and detects fluorescent X-rays generated from this substrate 11 by the measurement head 23 to detect an aluminum component contained in this substrate 11.

When there is an aluminum film which is composed of aluminum in the film 12 of the product substrate 10, the aluminum film correction means 33b corrects intensity of the fluorescent X-rays detected from the aluminum film by the measurement head 23 based on a detection result of the substrate aluminum detection means 33a to obtain the thickness of the aluminum film.

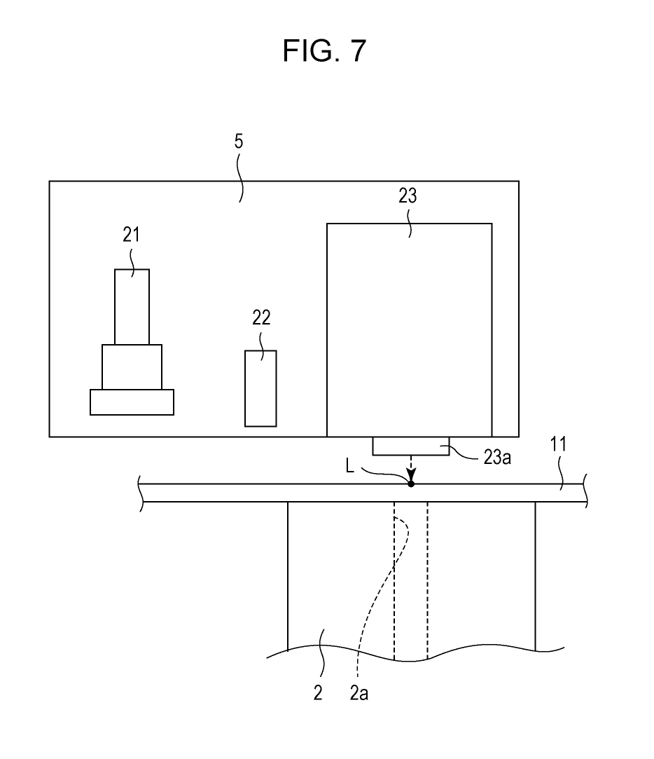

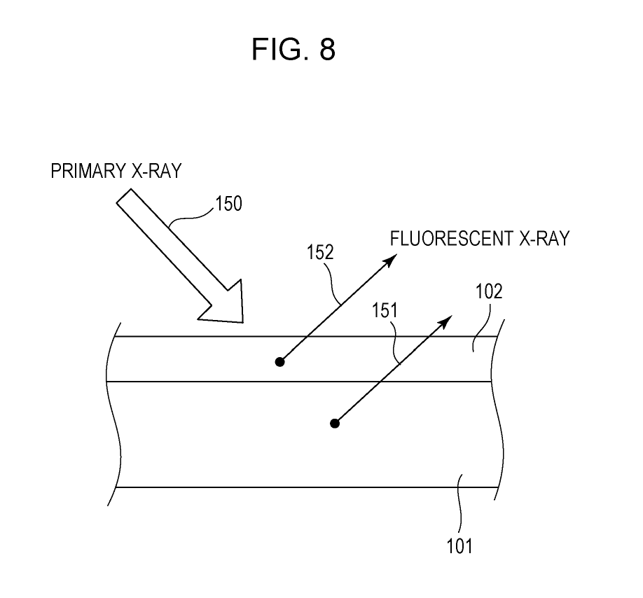

Specifically, as illustrated in FIG. 7, when the substrate 11 before film formation of the product substrate 10 is, for example, a glass substrate of Al₂O₃ and contains an aluminum component, the substrate 11 is placed on the substrate stage 2. Then, after adjusting height of the measurement head 23 by the displacement sensor 22, the fluorescent X-rays at a measurement position L of the substrate 11 are measured by the measurement head 23. The substrate aluminum detection means 33a detects the aluminum component of the substrate 11 based on this measurement value.

Subsequently, when the aluminum film is formed on the substrate 11, as illustrated in FIG. 3, the fluorescent X-rays at the measurement point P of the product substrate 10 are measured by the measurement head 23, while the aluminum film correction means 33b corrects the intensity of these fluorescent X-rays based on a detection result of the substrate aluminum detection means 33a to obtain the thickness of the aluminum film.

Accordingly, when the thickness of the aluminum film is obtained from the intensity of the fluorescent X-rays of the aluminum film detected by the measurement head 23, it is possible to exclude influences of aluminum contained in the substrate 11 of the product substrate 10 and to obtain the thickness of the aluminum film correctly.

The measurement position L of the substrate 11, which is measured by the measurement head 23, is overlapped with the air hole 2a provided in the substrate stage 2 in a plan view. Accordingly, even if a lot of primary X-rays penetrate the substrate 11 when the substrate 11 is irradiated with the primary X-rays from the measurement head 23 to detect the fluorescent X-rays from the substrate 11, these primary X-rays which have penetrated are to pass through a spatial region of the substrate stage 2.

Accordingly, it is possible to avoid the substrate stage 2 from being irradiated with the primary X-rays which have penetrated this substrate 11 to prevent the measurement head 23 from detecting the fluorescent X-rays generated from a substance constituting this substrate stage 2. Thus, it is possible to detect the aluminum component of the substrate 11 accurately.

Moreover, when the substrate 11 is measured by the measurement head 23, it is possible to closely adhere the substrate 11 to the substrate stage 2 by taking in air from the air holes 2a. Thus, it is possible to measure the measurement position L of the substrate 11 with height of the measurement position L of the substrate 11 stabilized.

The measurement position L (refer to FIG. 7) and the measurement point P (refer to FIG. 3) are preferably overlapped in a plan view, so that it is possible to obtain the thickness of the aluminum film more correctly. Note that, the measurement position L and the measurement point P may not be overlapped.

The substrate aluminum detection means 33a may detect the aluminum component of the substrate 11 before film formation for each of all the product substrates 10. This makes it possible to obtain the thickness of the aluminum film for all the product substrates 10 more accurately.

Further, the substrate aluminum detection means 33a may detect the aluminum component of the substrate 11 before film formation for each lot of all the product substrates 10. Accordingly, the thickness of the aluminum film is obtained based on the aluminum component of the substrate 11 before film formation for each lot of all the product substrates 10, thus making it possible to obtain the thickness of the aluminum film promptly and accurately.

Alternatively, the substrate aluminum detection means 33a may detect the aluminum component of the substrate 11 before film formation for at least one product substrate 10 of all the product substrates 10. Accordingly, the thickness of the aluminum film is obtained based on the aluminum component of the substrate 11 before film formation of at least one product substrate 10, thus making it possible to obtain the thickness of the aluminum film promptly.

As illustrated in FIG. 1, the measurement equipment calibration means 34 moves the measurement equipment 21, 22 and 23 to the calibration stage 3 to perform calibration of the measurement equipment 21, 22 and 23. The calibration of the measurement equipment 21, 22 and 23 is performed at a predetermined interval. This predetermined interval is, for example, at every predetermined time interval such that calibration is performed once a day or at every predetermined processing number such that calibration is performed after the film thickness of the predetermined number of the product substrates 10 is measured.

The first calibration sample 60 and the second calibration sample 70 are disposed in the calibration stage 3. The first calibration sample 60 is, for example, a sample for adjusting a gain of the fluorescent X-ray detection unit 232 of the measurement head 23. The second calibration sample 70 is, for example, a sample for adjusting an offset amount of each measurement equipment 21, 22 and 23.

Next, operation of the film thickness measurement device of the aforementioned configuration will be described.

As illustrated in FIG. 1, first, the product substrate 10 is conveyed onto the substrate stage 2 from a right direction (arrow R direction) of the film thickness measurement device. The product substrate 10 conveyed onto the substrate stage 2 is fixed at a predetermined position by the clamps 7. Then, the alignment mark is detected by the camera 21, and based on this detection result, position information of the product substrate 10 is corrected by the substrate position correction means 31.

Thereafter, at a first measurement point among a plurality of measurement points of the product substrate 10, distance in a height direction between the first measurement point and the displacement sensor 22 is measured by the displacement sensor 22. Based on this measurement value, the head position adjustment means 32 then adjusts a position in the height direction of the measurement head 23 so that distance between the first measurement point and the measurement head 23 has a setting value.

Subsequently, the measurement head 23 is moved immediately above the first measurement point by the head position adjustment means 32 and irradiates the film of the product substrate 10 with the primary X-rays to detect the fluorescent X-rays generated from this film. The analysis means 33 then obtains the thickness of the film from the intensity of these detected fluorescent X-rays.

Furthermore, for different measurement points of the product substrate 10 as well, the film thickness of the different measurement points is measured by the measurement head 23 after adjusting height of the measurement head 23 in the same manner.

In this manner, the film thickness of all measurement points of the product substrate 10 is measured, and based on this measurement result, whether or not the product substrate 10 is a defective product is judged.

Here, when the substrate 11 contains the aluminum component and an aluminum film is layered on this substrate 11, the substrate aluminum detection means 33a irradiates the substrate 11 before film formation with the primary X-rays from the measurement head 23 and detects fluorescent X-rays generated from this substrate 11 by the measurement head 23 to detect the aluminum component contained in this substrate 11. The aluminum film correction means 33b then corrects intensity of the fluorescent X-rays detected by the measurement head 23 from the substrate 11 after film formation of the aluminum film based on a detection result of the substrate aluminum detection means to obtain the thickness of the aluminum film.

Subsequently, the measurement equipment calibration means 34 moves the measurement equipment 21, 22 and 23 to the calibration stage 3 at a predetermined interval to perform calibration of the measurement equipment 21, 22 and 23.

Note that, the present invention is not limited to the aforementioned embodiment. For example, a plurality of films may be layered on the product substrate 10, and in this case, at least one film may be the aluminum film.

Moreover, the measurement position L of the substrate 11 measured by the measurement head 23 may be overlapped not with the air hole 2a of the substrate stage 2 but with the spatial region provided in the substrate stage 2.

Further, only the measurement head 23 may be provided by omitting the camera 21 and the displacement sensor 22. Furthermore, only the substrate stage 2 may be provided by omitting the calibration stage 3.

In addition, the first direction in which the gantry 4 extends and the second direction in which the gantry 4 moves may not be orthogonal but intersect with each other.

Further, the number of the cameras 21, the displacement sensors 22 and the measurement heads 23 may be plural and not limited to one.

Moreover, the film thickness measurement device of the present invention may measure film thickness of a large-sized or small-sized product substrate, and may measure film thickness of a semiconductor substrate of organic EL or the like other than the liquid crystal TFT.

### REFERENCE SIGNS LIST

1 base
2 substrate stage
2a air hole
3 calibration stage
4 gantry
5 slider
6 rail unit
7 clamp
10 product substrate
11 substrate
12 film
21 camera
22 displacement sensor
23 measurement head
30 control means
31 substrate position correction means
32 head position adjustment means
33 analysis means
33a substrate aluminum detection means
33b aluminum film correction means
34 measurement equipment calibration means
60 first calibration sample
70 second calibration sample
A first direction
B second direction

1. A film thickness measurement device, comprising:
a base (1);
a substrate stage (2) which is provided on the base (1) and on which a product substrate (10) having a film is placed;
a gantry (4) that extends in a first direction (A) with respect to the substrate stage (2) and is installed in the base (1) so as to be movable in a second direction (B) with respect to the substrate stage (2);
a slider (5) that is installed in the gantry (4) so as to be movable in the first direction (A);
a measurement head (23) that is fixed to the slider (5) and irradiates a film (12) of the product substrate (10) placed on the substrate stage (2) with primary X-rays to detect fluorescent X-rays generated from the film (12); and
analysis means (33) that obtains thickness of the film (12) from intensity of the fluorescent X-rays detected by the measurement head (23), wherein
the analysis means (33) includes
substrate aluminum detection means (33a) that irradiates a substrate (11) before film formation of the product substrate (10) with the primary X-rays from the measurement head (23) and detects fluorescent X-rays generated from the substrate (11) by the measurement head (23) to detect an aluminum component contained in the substrate (11), and
aluminum film correction means (33b) that, when an aluminum film composed of aluminum is included in the film (12) of the product substrate (10), corrects intensity of the fluorescent X-rays detected from the aluminum film by the measurement head (23) based on a detection result of the substrate aluminum detection means (33a) to obtain thickness of the aluminum film.

2. The film thickness measurement device according to claim 1, wherein
the substrate aluminum detection means (33a) detects the aluminum component of the substrate (11) before film formation for each of all the product substrates (10).

3. The film thickness measurement device according to claim 1, wherein
the substrate aluminum detection means (33a) detects the aluminum component of the substrate (11) before film formation for each lot of all the product substrates (10).

4. The film thickness measurement device according to claim 1, wherein
the substrate aluminum detection means (33a) detects the aluminum component of the substrate (11) before film formation for at least one product substrate (10) of all the product substrates (10).

5. The film thickness measurement device according to claim 1, wherein
when the substrate aluminum detection means (33a) detects the aluminum component of the substrate (11),
a measurement position of the substrate (11) to be measured by the measurement head (23) is overlapped with a spatial region provided in the substrate stage (2).

6. The film thickness measurement device according to claim 5, wherein
the spatial region provided in the substrate stage (2) is an air hole (2a) for taking in air or blowing air.
